(19) United States
(12) Patent Application Publication
(10) Pub. No.: US 2007/0281845 A1
(43) Pub. Date: Dec. 6, 2007

(54) Procedure for production of conical ice cream wrappers

(75) Inventor: Josep Ma VECIANA MEMBRADO, Reus Tarragona (ES)

Correspondence Address: SUGHRUE MION, PLLC, 2100 PENNSYLVANIA AVENUE, N.W., SUITE 800, WASHINGTON, DC, 20037, US

(73) Assignee: BIG DRUM, S.L., REUS (ES)

(21) Appl. No.: 11/757,721

(22) Filed: Jun. 4, 2007

(30) Foreign Application Priority Data
Jun. 5, 2006 (ES) P200601503

(51) Int. Cl. B31B 49/04; B31B 1/64

(52) U.S. Cl. 493/199

(57) ABSTRACT

This is a continuous mode procedure wherein in a first cutting operation an upper band (5) is obtained and a lower band (6), followed by a second cutting operation to obtain some separate trapezoidal segments (4), to finish with a third cutting operation on the curled side (10) of the segment (4) to obtain a circular side with only one radius of curvature, forming in this way a wrapper (11) of conical development.

### OBJECT OF THE INVENTION

The present invention is of application for the production of ice cream wrappers.

The object of the invention consists in the optimization of this production process with the purpose of minimizing the size of the disposable trimmings which are obtained after the stamping of the paper roil on which the wrappers are printed.

It is a further object of the invention that this production process takes place in continuous mode in order to reduce the times for obtaining the conical wrappers and the manipulation involved.

### BACKGROUND OF THE INVENTION

At the present time the production of conical wrappers in aluminum paper is carried out by a discontinuous system by means of which some superimposed sheets are stamped, and a series of segments are obtained which are then stacked prior to being sent to the cone-forming machine.

On these segments the prints that will later be stamped to define the wrappers have been carried out beforehand. These segments usually appear separate from each other defining an indented space between them.

Once the different segments have been stamped, the separating spaces between the same constitute disposable pieces of paper. The accumulation of these disposable pieces signifies a substantial paper loss and accumulation of waste.

The stamped segments are obtained with different orientations and require being stacked manually for their later continual feeding into the cone-forming machine.

Another possible solution for producing wrappers in discontinuous mode envisages the incorporation of a paper roll in which a series of separate printed segments appear, this paper is unwound passing through a stamping machine in which the segments are cut and which subsequently are stacked and pass to a cone-forming machine. The rest of the paper constitutes trim which is gathered on a roll.

The employment of paper rolls with the segments already printed is problematical due to the curling that takes place with the paper due to the effects of humidity and temperature. This dimensional variation greatly complicates the winding operation and can finally render it impossible in the most extreme cases, thereby determining an undesired outcome that requires the process to be stopped.

The operation of stamping in discontinuous mode to obtain ice cream wrappers therefore has a series of drawbacks which make the development of an alternative solution feasible

### DESCRIPTION OF THE INVENTION

The production procedure of conical ice cream wrappers which this invention discloses consists of a system in continuous mode wherein the segments, printed or to be printed, from which the wrappers are obtained, appear distributed on a supporting sheet preferably wound in a roll, from which the supporting sheet is extended to proceed to the cutting of each of these segments in accordance with some cutting lines and a sequence until the conical wrapper is obtained.

In a first cutting stage on the supporting sheet supplied in continuous mode some curied cutting lines are made and centered followed by some oblique cutting lines which divide the supporting sheet into an upper band and a tower band.

The upper and lower bands so defined can be rewound for their storage and later use, or they are directed toward the cone-forming machine.

Next a series of cuts are made on the upper and lower band respectively, more specifically some oblique cutting lines contiguous with the previous lines, and in this way obtain some separate segments.

These segments have an essentially trapezoidal configuration, in which each of them has two parallel sides of different length (longer side and shorter side), an inclined side and a curled side.

In another cutting operation carried out subsequently or at the same time as the previous one, a cut is made in the curled side, more specifically it concerns transforming the curled side into a curved side with a single radius of curvature, for which reason a cut is made from the point of inflection of this side following the same curvature to the vertex defined between the inclined side and the shorter parallel side.

The surplus piece is of reduced size and has an essentially triangular configuration with circular base.

This way a wrapper of conical development is defined, which when folded in the one-forming machine adopts the conical configuration of a wrapper for ice creams.

In a preferred manner, it is envisaged that the supporting sheet stored on the roll is not printed or has some preprint, thereafter when the supporting sheet is unwound from the roll, it is possible to print thereon defining printed segments which are cut thereafter in accordance with the stages described.

In the event of using the wound supporting sheet with the segments already printed, the employment is envisaged of means for positional control which correct possible positional misalignments of the printed segment, confronting the printed segment with the stamping machine and so carrying out the cut in the precise place.

Complementarily it is envisaged that the size of the printed segment is slightly greater than the size of the piece that is finally stamped thus avoiding small misalignments which could result in pieces with sections without printing.

It is envisaged that the supporting sheet (1) is constituted by several layers of materials selected among, paper and aluminum composite, paper and plastic composite, different types of plastic and paper, aluminum or plastic only.

### DESCRIPTION OF THE DRAWINGS

To complete the description that is being made and with the object of assisting in a better understanding of the characteristics of the invention, and in accordance with a preferred example of practical embodiment thereof, the same is accompanied, as an integral part of said description, with a set of drawings wherein by way of illustration and not restrictively, the following has been represented:

FIG. 1.—It shows a plan view in which the first cutting made on the supporting sheet is observed.

FIG. 2.—It shows a plan view in which the upper and lower segment bands are observed, obtained after carrying out the first cutting operation on the supporting sheet.

FIG. 3.—It shows a plan view in which the practiced cutting lines are appreciated in a second cutting operation performed on the upper or lower bands.

FIG. 4.—It shows a plan View of the segment obtained from the second cutting operation.

FIG. 5.—It shows a plan view in which the third cutting operation is observed carried out on each of said segments in which a corner piece is cut from the segment in order to obtain the wrapper of conical development.

FIG. 6.—It shows a plan view of the finally obtained wrapper of conical development.

FIG. 7.—It shows a schematic View of the facility used to carry out the procedure of the invention.

### PREFERRED EMBODIMENT OF THE INVENTION

In the light of the preceding figures a preferred made of embodiment is described hereunder of the procedure for production of conical wrappers which constitutes the object of this invention.

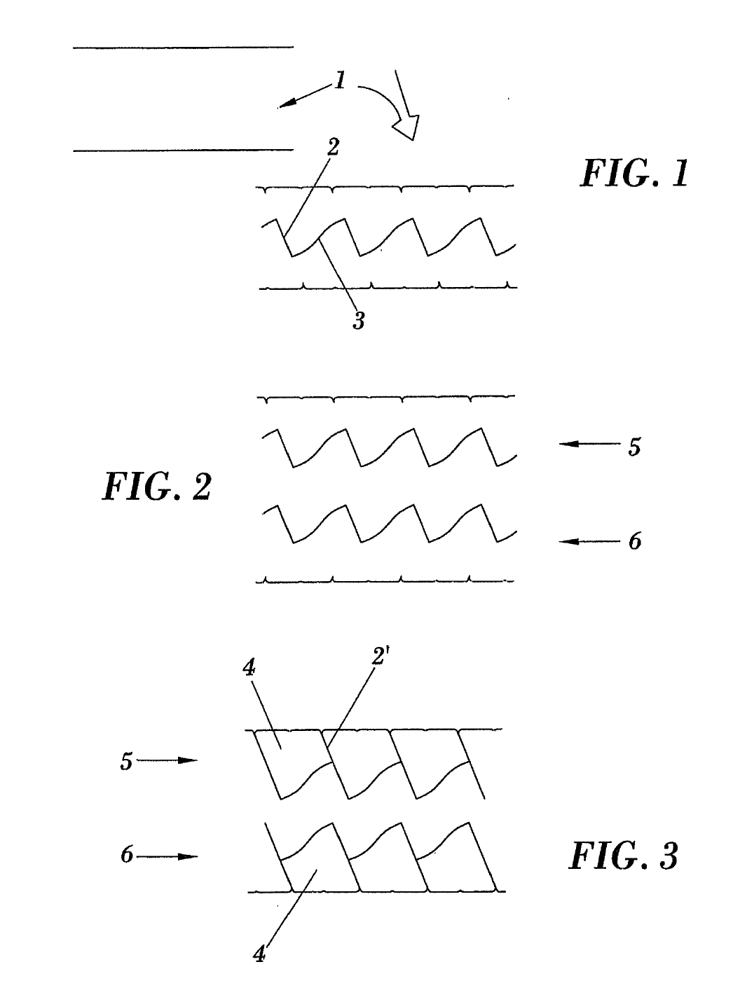

In FIG. 1 the supporting sheet (1) is observed based on which the wrappers (11) of conical development will be obtained, in accordance with a procedure in continuous mode.

Beginning with a supporting sheet (1) on which a first cutting operation is carried out, according to FIG. 1, practicing thereafter some first parallel and oblique cutting lines (2) followed by some curled cutting lines (3) in order to obtain an upper band (5) and a lower band (6), such as one observes in FIG. 2.

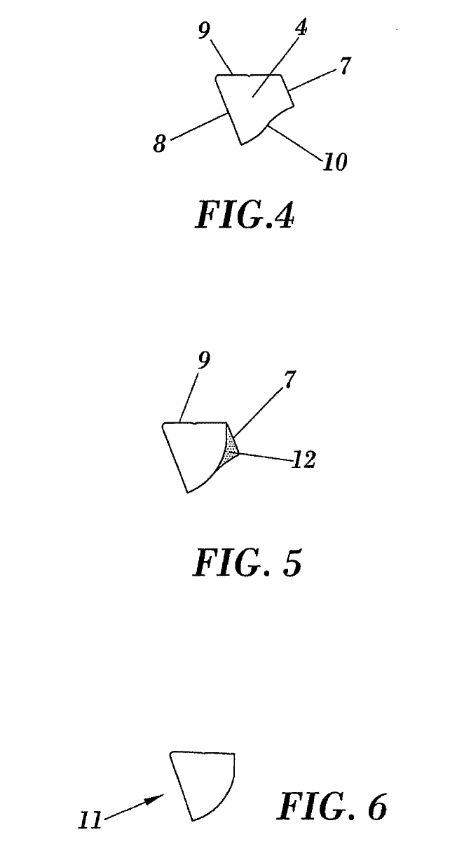

Next a second cutting operation is carried out on the upper band (5) and on the lower band (6) through some second oblique cutting lines (2′) practiced after the first oblique cutting lines (2), as can be seen in FIG. 3 in order to obtain a series of segments (4) of similar dimensions and shape, already separate, as have been represented in FIG. 4, of essentially trapezoidal configuration, configured by a shorter side (7) and a longer side (8) in parallel, an inclined side (9) and a curled side (10) opposite the inclined side (9).

In FIG. 5 a third cutting operation is observed consisting in performing a cut in the curled side (10) of the segment (4) from its point of inflection to the vertex defined between the inclined side (9) and the shorter side (7), in order to transform the curled side (10) into a circular side having only one radius of curvature, thereby conforming the wrapper (11) of conical development represented in FIG. 6. As a consequence of the cut a corner piece (12) is discarded.

This wrapper (11) has been obtained in a preferred manner according to a procedure in continuous mode and Is fed directly to the cone-forming machine in which the wrapper is folded to obtain the conical configuration in which the ice cream is wrapped.

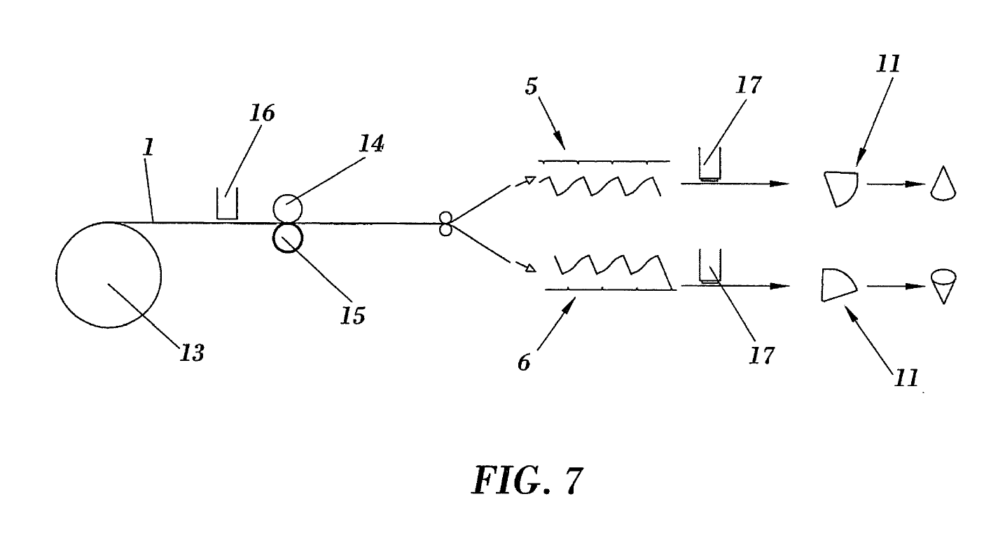

In FIG. 7 the continuous-mode process is shown for production of conical ice cream wrappers for the case in which the supporting sheet (1) is on a roll (13) from which it is unwound. Prior to carrying out the first cutting, by means of a cutter roller (14) which is represented facing a rubber roller (15), the printing is carried out on the supporting sheet (1) by means of a printing head (16).

After the first cut the second and third cut is made of each of the upper (5) and lower (6) bands by means of cutting heads (17), which can form part of the cone-forming machine in order to finally obtain the wrapper (11) of conical development which is folded in said cone-forming machine to produce the conical form represented.

1. Procedure for production of conical ice cream wrappers characterized in that it consists of a continuous procedure mode in which the following operations are carried out:
first cutting operation on a supporting sheet (1) initially stored on a roll (13), practicing successively some first parallel and oblique cutting lines (2) followed by some curled cutting lines (3) to obtain an upper band (5) and a lower band (6),
second cutting operation, on the upper band (5) and on the lower band (6) through second oblique cutting lines (2′) practiced after the first oblique cutting lines (2), in order to obtain a series of segments (4) of similar dimensions and shape, already separate, of essentially trapezoidal configuration, configured by a shorter side (7) and a longer side (8) in parallel, an inclined side (9) and a curled side (10) opposite the inclined side (9),
third cutting operation consisting in the implementation of a cut in the curled side (10) of the segment (4) from its point of inflection to the vertex defined between the inclined side (9) and the shorter side (7), in order to transform the curled side (10) into a circular side with only one radius of curvature, thereby conforming the wrapper (11) of conical unrolled shape.

2. Procedure for production of conical ice cream wrappers according to claim 1 characterized in that after the first cutting operation the upper band (5) and the lower band (6) are stored on rolls prior to the second and third cutting operations.

3. Procedure for production of conical ice cream wrappers according to claim 1 characterized in that the second and third cutting operations are carried out at the same time.

4. Procedure for production of conical ice cream wrappers according to claim 1 characterized in that the supporting sheet (1) is printed after being unwound from the roll (13) and prior to the first cutting

5. Procedure for production of conical ice cream wrappers according to claim 1 characterized in that the supporting sheet (1) stored on the roll (13) is printed, and prior to the first cut a positional correction is made of the supporting sheet (1).

6. Procedure for production of conical ice cream wrappers according to claims 1, 4 and 5 characterized in that the supporting sheet (1) consists of several layers of materials selected from, paper and aluminum composite, paper and plastic composite, different types of plastic and paper, aluminum or plastic only.
